(19) United States
(12) Patent Application Publication
(10) Pub. No.: US 2024/0117744 A1
(43) Pub. Date: Apr. 11, 2024

(54) AEROFOIL FOR A GAS TURBINE ENGINE

(71) Applicant: ROLLS-ROYCE plc, London (GB)

(72) Inventors: Bogachan ALPAN, Derby (GB); Jonathan M. PEACE, Derby (GB); Thomas P. HOUGHTON, Derby (GB)

(73) Assignee: ROLLS-ROYCE plc, London (GB)

(21) Appl. No.: 18/467,387

(22) Filed: Sep. 14, 2023

(30) Foreign Application Priority Data
Oct. 10, 2022 (GB) 2214883.7

(51) Int. Cl. F01D 5/18; F01D 9/04; F01D 25/12

(52) U.S. Cl. CPC F01D 5/187; F01D 9/041; F01D 25/12

(57) ABSTRACT

Disclosed is an aerofoil for a gas turbine engine comprising: a first conduit formed in the aerofoil; a second conduit formed in the aerofoil; and a dividing wall separating the first and second conduits, the dividing wall comprising a transfer port configured to permit fluid flow between the first and second conduits; wherein the dividing wall further comprises a reinforcing boss at least partially encircling the transfer port. Also disclosed is a gas turbine engine comprising the aerofoil and an aircraft comprising the gas turbine engine.

### CROSS-REFERENCE TO RELATED APPLICATIONS

This specification is based upon and claims the benefit of priority from United Kingdom patent application number GB 2214883.7, filed on Oct. 10, 2022, which is hereby incorporated herein in its entirety.

### BACKGROUND

### Technical Field

This disclosure concerns aerofoils for gas turbine engines.

### Description of the Related Art

Aerofoils for gas turbine engines may comprise one or more internal passages for transporting fluids, such as cooling fluids, within the aerofoil. Such aerofoils may comprise openings or ports or transferring fluids between multiple internal passages within the aerofoil. It will be appreciated that improvements in the field of aerofoils are desirable.

### SUMMARY

According to a first aspect of the present disclosure, there is provided an aerofoil for a gas turbine engine comprising: a first conduit formed in the aerofoil; a second conduit formed in the aerofoil; and a dividing wall separating the first and second conduits, the dividing wall comprising a transfer port configured to permit fluid flow between the first and second conduits; wherein the dividing wall further comprises reinforcing boss at least partially encircling the transfer port.

The first and second conduits may be chambers or channels within the aerofoil. The first and second conduits may be substantially elongate. The first and second conduits may be in fluid communication with a cooling fluid system of the gas turbine engine.

The dividing wall may have a substantially constant thickness or a variable thickness.

The reinforcing boss may be a protruding feature at least partially surrounding the transfer port. The reinforcing boss and the dividing wall may be formed as a single continuous component or in one piece. The aerofoil may be formed as a single component, or may be formed from a plurality of components.

At least partially encircling the transfer port may require encircling at least 10%, at least 25%, at least 33%, at least 50%, at least 66%, or at least 75% of the perimeter of the transfer port.

The reinforcing boss may substantially or completely encircle the transfer port. Completely encircling the transfer port may require encircling 100% of the perimeter of the transfer port.

The dividing wall may comprise a plurality of transfer ports, and wherein the reinforcing boss substantially encircles two or more of the plurality of transfer ports.

The number of reinforcing bosses provided may be less than the number of transfer ports.

The transfer port or ports may be non-cylindrical in shape.

The reinforcing boss may protrude from the dividing wall into: a) the first conduit only; b) the second conduit only; or c) both the first and second conduits.

The reinforcing boss may be formed as a reinforcing pad having a thickness substantially greater than the thickness of a surrounding portion of the dividing wall. The reinforcing boss is at least 10% or 20% greater in thickness than a surrounding area or portion of the dividing wall.

The reinforcing boss may extend away from the perimeter of the transfer port across the dividing wall (i.e., laterally and/or radially across the dividing wall from the perimeter of the transfer port). The reinforcing boss may extend across the dividing wall laterally from the perimeter of the transfer port by a distance of at least 50% of a diameter of the transfer port. Where the transfer port is non-circular in cross section or non-cylindrical, the diameter may be a maximum diameter of the port or a minimum diameter of the port.

The reinforcing boss comprises a fillet or chamfer at an interface of the reinforcing boss with the dividing wall. The reinforcing boss may comprise a tapering portion over which the thickness of the dividing wall increases at a gradient of at least 0.25:1 or 0.5:1.

The first and second conduits may be configured to transport a cooling fluid for cooling the aerofoil. The aerofoil may contain further conduits in addition to the first and second conduits.

The aerofoil may be: a) a turbine or nozzle guide vane; or b) a turbine blade. A plurality of aerofoils may be provided to form an annular disk.

The aerofoil may be configured or arranged to extend in a substantially radial direction when installed in a gas turbine engine. The first and second conduits may be configured to extend in a substantially radial direction with respect to the gas turbine engine when installed in a gas turbine engine.

The reinforcing boss may be shaped to alleviate stress concentrations in the aerofoil around the transfer port. The reinforcing boss may be non-circular. The reinforcing boss may be aligned according to the local stress field in the dividing wall. A largest diameter of the reinforcing boss may be arranged substantially at a tangent to peak stress fields in the dividing wall.

The aerofoil may further comprise one or more cooling holes extending from the first and/or second conduits to an exterior surface of the aerofoil.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

The gearbox may be a reduction gearbox (in that the output to the fan is a lower rotational rate than the input from the core shaft). Any type of gearbox may be used. For example, the gearbox may be a “planetary” or “star” gearbox, as described in more detail elsewhere herein.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

According to an aspect, there is provided an aircraft comprising a gas turbine engine as described and/or claimed herein.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### DESCRIPTION OF THE DRAWINGS

Embodiments will now be described by way of example only with reference to the accompanying drawings, which are purely schematic and not to scale, and in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 is a plan view of an aerofoil for a gas turbine engine;

FIG. 5 is a sectional view of the aerofoil of FIG. 4;

FIG. 6 is a further sectional view of the aerofoil of FIG. 4; and

FIG. 7 is a view of an aircraft comprising a gas turbine engine.

### DETAILED DESCRIPTION

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The turbines 17, 19 comprise aerofoils 100, in the form of blades and vanes. The fan 23 generally provides the majority of the propulsive thrust. The epicyclic gearbox 30 is a reduction gearbox.

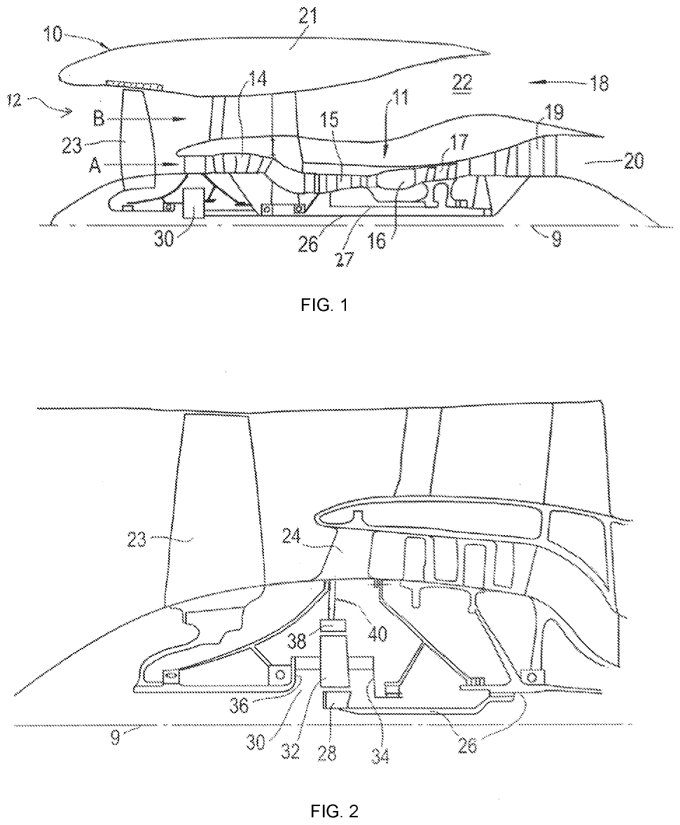

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

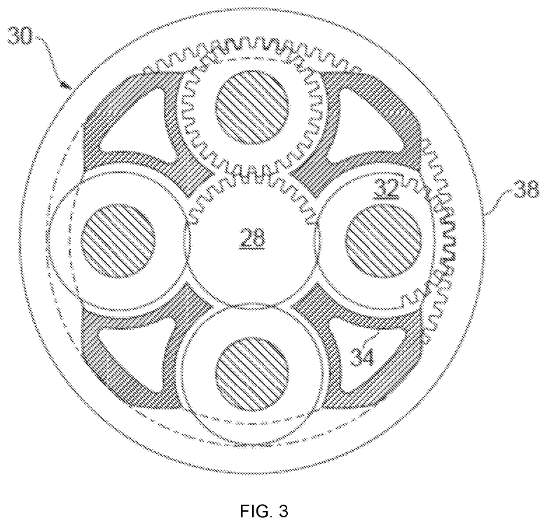

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the present disclosure. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input, and output shaft arrangement, and bearing locations.

Optionally, the gearbox may drive additional and/or alternative components (e.g., the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

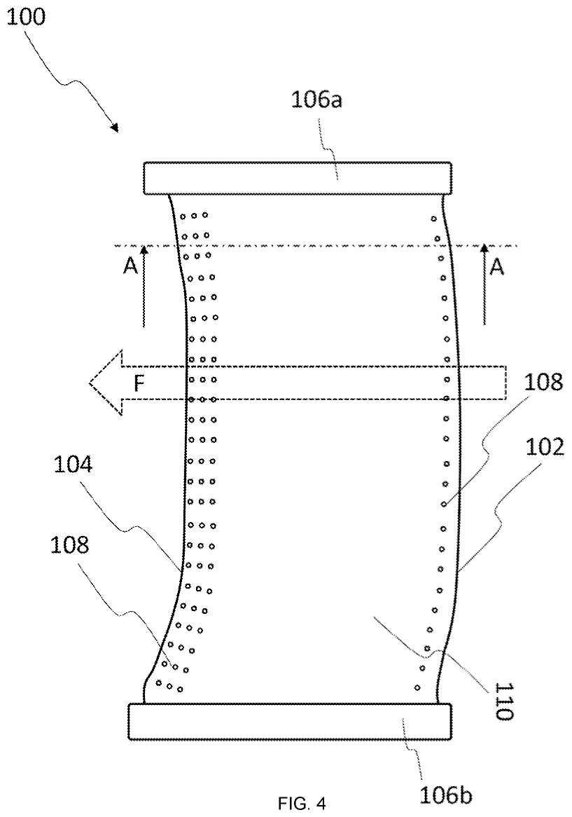

An aerofoil 100 of the gas turbine engine 10 is schematically shown in more detail in FIG. 4. The aerofoil 100 comprises a leading edge 102 and a trailing edge 104. In use, the leading edge 102 is arranged axially ahead of the trailing edge 104 in the engine 10, such that fluid flow through the engine 10 passes over the aerofoil from the leading edge 102 to the trailing edge 104 as shown by arrow F. The aerofoil 100 spans between first (or outer) and second (or inner) platforms 106a,b for securing the aerofoil 100 in place in the engine 10. In use, the leading and trailing edges 102,104 (and consequently the aerofoil 100 as a whole) is configured to extend in a radial direction in the gas turbine engine. In the illustrated example, the aerofoil is a stator vane (or nozzle guide vane) for the turbine 17 and therefore platforms 106a,b are provided at the radially-inner and radially-outer ends of the aerofoil 100 to secure both ends. In other examples, the aerofoil may be a blade for the turbine, in which case a platform may only be provided at one end, such as the radially inner end of the blade. A plurality of aerofoils 100 may be provided to form an annular disk in the turbine 17.

The exterior surface of the aerofoil 100 comprises a plurality of cooling holes 108 for ejecting a cooling fluid flow to cool the aerofoil 100 in use.

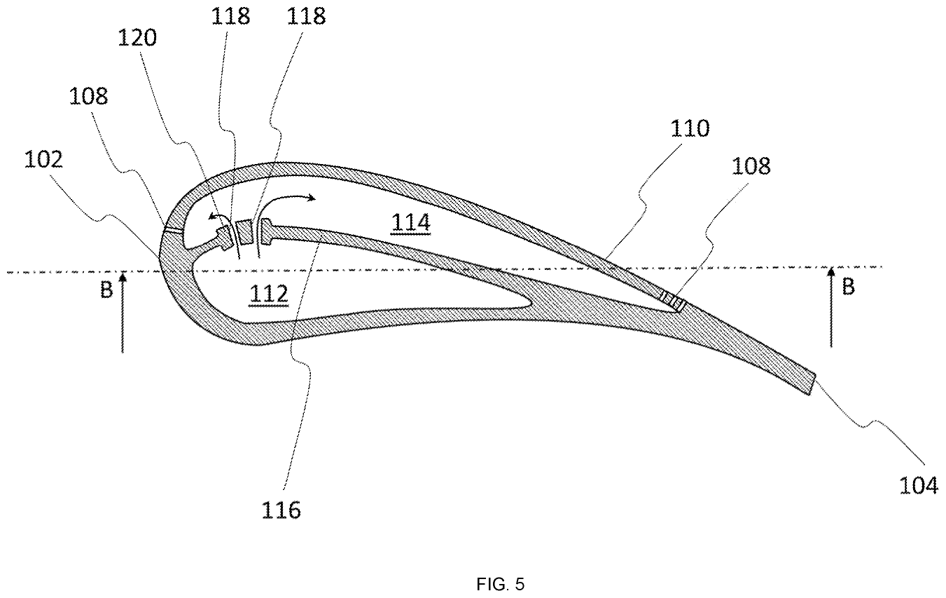

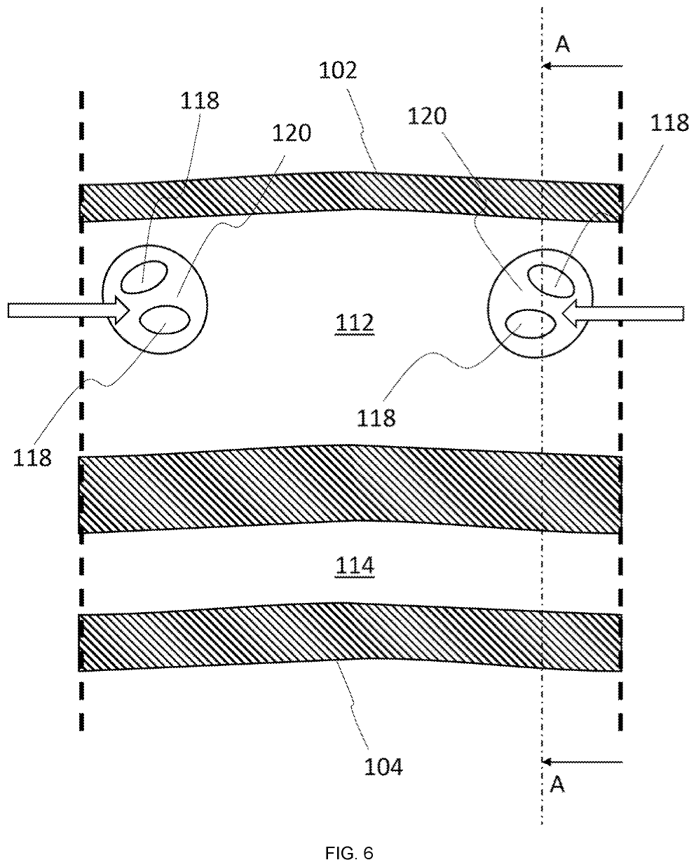

FIG. 5 schematically shows the cross-section of the aerofoil 100 along the plane A-A shown in FIGS. 4 and 6, i.e., along the span of the aerofoil 100. The aerofoil 100 comprises an exterior wall 110 which defines the external profile of the aerofoil 100 and defines its characteristics and performance. Within the aerofoil 100, a first conduit 112 and a second conduit 114 are formed. The first and second conduits 112,114 extend along the radial span of the aerofoil 100 and are configured to receive cooling fluid and transport the cooling fluid along the span of the aerofoil 100 to be expelled from the cooling holes 108. As can be appreciated in FIG. 5, the cooling holes 108 extend through the exterior wall 110 from the first and/or second conduits to the exterior of the aerofoil 100.

In this way, the cooling fluid is able to cool the interior and the exterior of the aerofoil 100. The conduits 112,114 take the form of internal chambers or channels within the aerofoil 100. One or both of the conduits 112,114 are in fluid communication with a cooling fluid system of the gas turbine engine to receive cooling fluid, commonly cooling air therefrom.

The first and second conduits 112,114 are separated along the span of the aerofoil 100 by a dividing wall 116. The dividing wall 116 provides structural support to the aerofoil 100, but it also inhibits fluid transfer between the first and second conduits 112,114. The dividing wall 116 has a substantially constant thickness, T, in this example, but in other examples, its thickness may vary more significantly along its length. Although the illustrated aerofoil 100 comprises two conduits, other examples may contain further conduits in addition to the first and second conduits.

In order to permit cooling fluid transfer between the conduits 112,114 the dividing wall comprises a plurality of transfer ports 118 which extend through the dividing wall 116 so as to provide cooling fluid transfer paths between the conduits 112,114, as illustrated by the arrows in FIG. 5 FIG. 6 schematically shows a partial cross-sectional view of the aerofoil 100 along the plane B-B shown in FIG. 5. This view shows the dividing wall 116 and the transfer ports 118 in more detail.

As can be appreciated from FIGS. 5 and 6, the aerofoil 100, and more specifically, the dividing wall 116 comprises a reinforcing boss 120. In this example, the dividing wall 116 comprises two reinforcing bosses 120 which are provided at separate locations along the span of the aerofoil 100. The reinforcing bosses 120 encircle (i.e., extend around) each of the transfer ports 118.

The reinforcing bosses 120 take the form of an area of local thickening of the dividing wall 116 surrounding the transfer ports 118. In this example, the reinforcing boss 120 extends around the entire periphery or perimeter of each transfer port 118, but it should be understood that in other examples, the reinforcing boss may extend only partially around the periphery of a transfer port. For example, if the transfer ports 118 are provided on a dividing wall having significant curvature, the reinforcing bosses may extend only partially around the transfer port or ports on one or both sides of the dividing wall, resulting in a non-uniform thickness. The reinforcing boss 120 may be non-circular.

In this example, the reinforcing boss 120 protrudes from the dividing wall 116 into both the first and second conduits 112,114 (i.e., it protrudes from both sides of the dividing wall 116). In other examples, the reinforcing boss may protrude from the dividing wall 116 into the first conduit or second conduit only. In this example, the dividing wall 116 and the reinforcing bosses 120 are formed as a single continuous component or in one piece. More generally, the entire aerofoil 100 is formed as a single component. However, in other examples, the various parts of the aerofoil described herein may be formed from a plurality of separate components which are assembled into the aerofoil.

As can be appreciated in FIG. 6, each of the reinforcing bosses 120 is a continuous area of local thickening which encircles two transfer ports 118. By providing a single reinforcing boss 120 which encircles a plurality of transfer ports 118, the geometry of the dividing wall 116 around the transfer ports 118 can be simpler to manufacture while still adequately reinforcing the transfer ports 120. In this example, each of the reinforcing bosses 120 can be considered as a reinforcing pad through which a plurality of transfer ports 118 are formed. A plurality of transfer ports 118 share a common reinforcing boss 120. The number of reinforcing bosses provided may be less than the number of transfer ports.

As can be best understood from FIG. 5, the reinforcing boss 120 has a thickness TR which is substantially greater than the thickness T of the surrounding portion of the dividing wall 116. In this example, the reinforcing boss is at least 10% greater in thickness than the surrounding portion of the dividing wall, and may be at least 20% greater in thickness than the surrounding portion.

Each reinforcing boss 120 extends away from the perimeter of the transfer port 118 (i.e., laterally and/or radially) across the dividing wall 116. In this example, the reinforcing boss 120 extends across the dividing wall 116 laterally from the perimeter of the transfer port by a distance E, which is at least 50% of a diameter D of the transfer port. Where the transfer port 118 is non-circular in cross section or non-cylindrical as per this example, it should be understood that the diameter D may be a maximum diameter of the port 118 or a minimum diameter of the port 118.

Each reinforcing boss 120 comprises a fillet at its interface with the dividing wall 116. In other examples, a less abrupt interface may be provided; for example, the reinforcing boss may comprise a tapering peripheral portion over which the thickness of the dividing wall increases at a gradient of at least 0.25:1 or 0.5:1.

As shown in FIG. 6, in this example, each of the transfer ports 118 is non-cylindrical in shape. Providing non-cylindrical transfer ports optionally in combination with the reinforcing boss 120 may provide improved stress reduction and fluid flow. The reinforcing boss and the non-cylindrical holes may be designed with profiles optimised with respect to the local stress field.

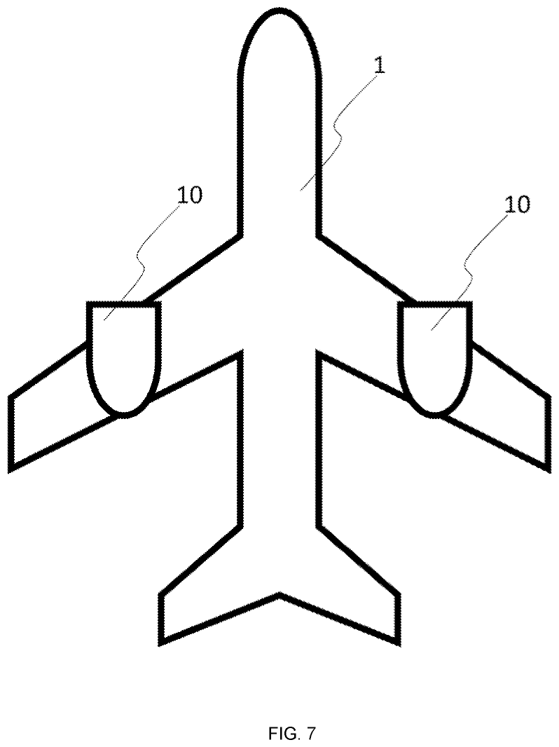

An aircraft 1 comprising a gas turbine engine 10 is shown in FIG. 7.

The aerofoils, gas turbine engines, and aircraft disclosed herein may provide various advantages. The aerofoil constructions disclosed herein may be shaped to improve strength and/or alleviate stress concentrations in the aerofoil around the transfer port, and thereby extend component life or reduce maintenance requirements. The aerofoils disclosed herein may provide improved fluid flow and improved heat transfer within the aerofoil. Exemplary aerofoils may be manufactured by various means, such as soluble core transfer to ceramic core and casting.

Although the illustrated example relates to a turbine vane or blade, it should be understood that the principles of the disclosure are equally applicable to various aerofoils in a gas turbine engine, such as for transfer or feed holes, impingement holes, dual-wall aerofoils, or multi-pass aerofoils.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein. The scope of protection is defined in the appended claims.

What is claimed is:

1. An aerofoil for a gas turbine engine comprising:
a first conduit formed in the aerofoil;
a second conduit formed in the aerofoil; and
a dividing wall separating the first and second conduits, the dividing wall comprising a transfer port configured to permit fluid flow between the first and second conduits;
wherein the dividing wall further comprises a reinforcing boss at least partially encircling the transfer port.

2. The aerofoil for a gas turbine engine as claimed in claim 1, wherein the reinforcing boss substantially encircles the transfer port.

3. The aerofoil for a gas turbine engine as claimed in claim 1, wherein the transfer port is non-cylindrical in shape.

4. The aerofoil for a gas turbine engine as claimed in claim 1, wherein the dividing wall comprises a plurality of transfer ports, and wherein the reinforcing boss substantially encircles two or more of the plurality of transfer ports.

5. The aerofoil for a gas turbine engine as claimed in claim 1, wherein the reinforcing boss protrudes from the dividing wall into at least one of the first conduit and the second conduit.

6. The aerofoil for a gas turbine engine as claimed in claim 1, wherein the reinforcing boss is at least 10% greater in thickness than a surrounding area of the dividing wall.

7. The aerofoil for a gas turbine engine as claimed in claim 1, wherein the reinforcing boss extends across the dividing wall away from the perimeter of the transfer port by a distance of at least 50% of a diameter of the transfer port.

8. The aerofoil for a gas turbine engine as claimed in claim 1, wherein the first and second conduits are configured to transport a cooling fluid for cooling the aerofoil.

9. The aerofoil for a gas turbine engine as claimed in claim 1, wherein the aerofoil is selected from the group consisting of a turbine guide vane, a nozzle guide vane, and a turbine blade.

10. The aerofoil for a gas turbine engine as claimed in claim 1, wherein the first and second conduits are configured to extend in a substantially radial direction with respect to the gas turbine engine when installed in a gas turbine engine.

11. An aerofoil for a gas turbine engine as claimed in claim 1, wherein the reinforcing boss is shaped to alleviate stress concentrations in the aerofoil around the transfer port.

12. The aerofoil for a gas turbine engine as claimed in claim 1, further comprising one or more cooling holes extending from the first and/or second conduits to an exterior surface of the aerofoil.

13. A gas turbine engine for an aircraft, the gas turbine engine comprising the aerofoil of claim 1.

14. The gas turbine engine of claim 13, further comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft.

15. The gas turbine engine according to claim 14, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

16. An aircraft comprising a gas turbine engine according to claim 13.
